(19) United States
(12) Patent Application Publication
(10) Pub. No.: US 2012/0201978 A1
(43) Pub. Date: Aug. 9, 2012

(54) UNIVERSAL CONNECTABLE, COLLECTABLE OBJECT OR OBJECTS

(76) Inventor: William T. WILKINSON, Media, PA (US)

(21) Appl. No.: 13/343,703

(22) Filed: Jan. 4, 2012

Related U.S. Application Data
(60) Provisional application No. 61/429,744, filed on Jan. 4, 2011.

(51) Int. Cl. A63H 33/42; A63H 33/30; B32B 3/06

(52) U.S. Cl. 428/16; 428/99; 428/100; 428/34.1

(57) ABSTRACT

The present invention provides a universal connectable collectable comprising two or more structures that are connectable to each other by the use of a universal connector. With a universal connector, the connectable collectable one can create an infinite number of structures by connecting various structures together. Since the universal connector can be provided on each structure, one can not only chose the two or more structures to connect but the structures can be connected at various places on each structure.

### CROSS REFERENCE TO RELATED APPLICATION

The present application claims the benefit of U.S. Provisional application No. 61/429,744 filed Jan. 4, 2011. The provisional application is hereby incorporated in its entirety by reference.

### BACKGROUND OF THE INVENTION

There have been various figures or collectables that have some degree of connectability between the figures. However, they have a small and finite set of figures for play and are not designed for an infinite number of connectable combinations and do not constitute a collectable group.

### SUMMARY OF THE INVENTION

The present invention provides a universal connectable collectable object comprising the whole object, or one or more parts of the object, and one or more connectors on each object, or each part of an object for connecting the object or the parts of an object, wherein the whole object or one or more parts of the object are removeably connectable to each other.

One object of the present invention is to provide a finite or infinite collectable group.

### BRIEF DESCRIPTION OF THE DRAWINGS

FIG. 1 illustrates simple connectable objects of the present invention.

FIG. 2 illustrates variations of simple connectable objects of the present invention.

FIG. 3 illustrates complex connectable objects of the present invention.

FIG. 4 illustrates variations in the connectable surface material of the present invention.

### DETAILED DESCRIPTION OF THE INVENTION

The present invention relates to universal connectable collectable objects.

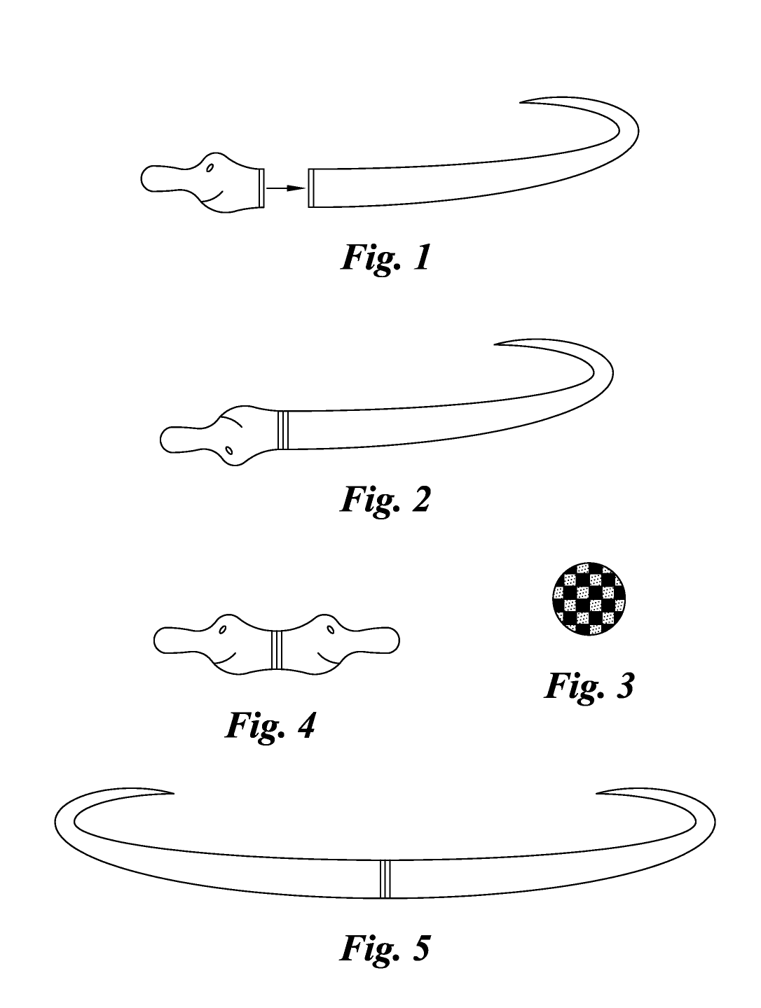

As shown in FIGS. 1 and 2, the present invention provides a simple collectable object.

As shown in FIG. 3 the present invention provides complex collectable objects. The drawings illustrate a toothbrush combined with a floss dispenser and bristle cover. Various parts can be combined interchangeably resulting in an infinite number of characters.

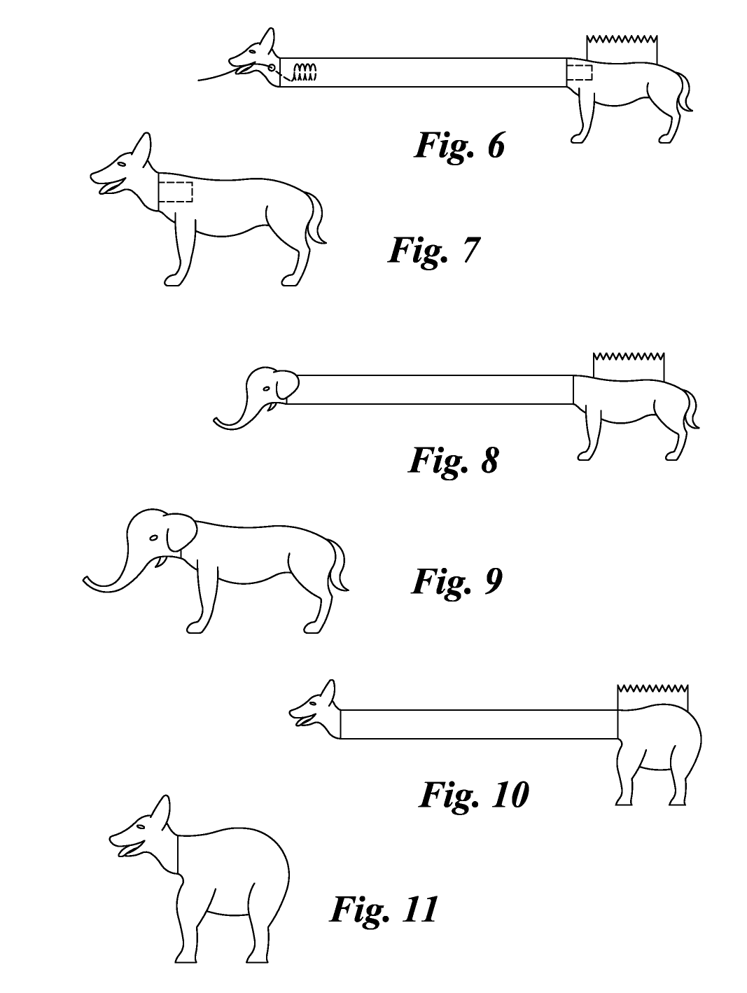

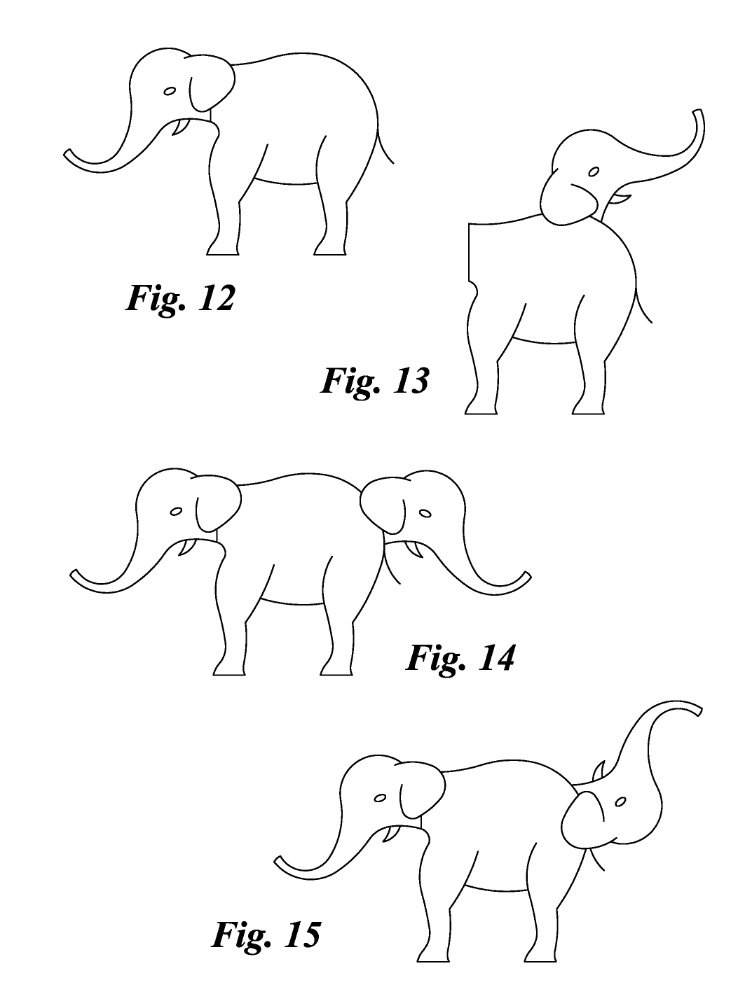

As also shown in FIG. 4, the present invention can include unique connectable surface material for joining different parts in unique combinations and in unique ways.

Broad speaking, the present invention can comprise a one, or preferably more than one object or part of an object, and one, two or preferably three dimensional object/structure of any kind, that can be joined or connected by any means, to itself, and/or part of itself, or to any other object or objects, and/or preferably parts of another object or objects, to create a collectable object, or preferably a group of collectable objects. The object or objects can be permanently attached, or are detachable from one, or preferably detachable from more than one other object(s) or it's parts.

The collectable object(s) of the present invention can be of two types: A) A simple collectable object or objects having only one main purpose, that being to create a collectable or collectable group; and B) A complex collectable, or preferably complex collectable group, having more than one purpose, aside from being just a collectable or collectable group.

The object(s) can be of any type (animate or inanimate), shape, size or composition, but are preferably small in size, made of inexpensive materials, so as to be affordable, and easily collectable to the greatest number of people.

The object(s) can be solid or hollow inside. If hollow, various things or products can be stored inside, such as product samples for promotional marketing, or licensing. The hollow object can serve as a product container for food, candy, gum and many other products.

Each object can have one, or preferably more than one connector for each whole object, such as preferably one connector on each part of an object, that is divided into preferably two or more than two parts. A two-part object would preferably be a head and a body, or a top and a bottom. Connectors can be different, or preferably of the same type. Connectors can be different, or preferably of the same size. Finally, a connector or connectors can be positioned in different, or preferably the same location on an object, or parts of an object.

Objects can be in one piece, but are preferably in more than one piece or part, and preferably in two parts, that when joined or connected together, form the whole object.

The present invention has many practical applications. As previously described, the invention has a basic form, as a simple/sole collectable, but the preferable form/embodiment of the invention is a complex collectable, that can be applied to, and adapted for many different applications. Therefore, we claim the invention (connectable collectable object(s)), preferably used for one or more purposes of any kind, (in addition to the basic/simple collectable purpose), for several purposes.

Examples of Invention include a simple collectable connectable such as a “Beanie Babies,” which is a simple collectable toy.

An example of a complex collectable includes the “FlossBrush” connectable, collectable toothbrush. The “FlossBrush” connectable can be a simple collectable, a connectable toy, a toothbrush, a toothbrush holder/stand, a sanitary bristle cover, a floss dispenser and a toothpaste tube cap.

Other variations are also possible within the concepts of this invention.

We claim:

1. A universal connectable collectable object comprising the whole object, or one or more parts of the object, and one or more connectors on each object, or each part of an object for connecting the object or the parts of an object, wherein the whole object or one or more parts of the object are removeably connectable to each other.

2. The universal connectable collectable of claim 1 wherein the whole object or parts of an object can be of any type, size, shape or material and wherein the two parts are connected, they form either part of a larger structure or a complete structure.

3. The universal connectable collectable of claim 1 wherein the connector can be of any type, size, shape or material.

4. The universal connectable collectable of claim 3 wherein the connector covers the whole object or object part so that the whole object or object part can connect anywhere to itself or to another object or object part.

5. The universal connectable collectable of claim 1 wherein the connectable is a simple connectable, wherein the two parts are a head and body of an animal and wherein the head and body are removeably connected by a connector.

6. The universal connectable collectable of claim 5, wherein the connector is at least one selected from the group consisting of Velcro, hook and loop, magnet, snap, button and hole, zipper, post and hole and sticky material.

7. A universal connectable collectable of claim 1, wherein the connectable collectable is a simple connectable collectable, and wherein the connectable collectable object or object parts have one or more purposes, in addition to being simply a connectable collectable.

8. The universal connectable collectable of claim 7 wherein the connector on a whole object or on one or more parts of an object includes both hook and loop material.

9. The universal connectable collectable of claim 1 wherein the connectable is a complex connectable collectable, having one or more functions or purposes in addition to being simply a connectable collectable.

10. The universal connectable collectable of claim 1 wherein the connectable collectable further comprises at least one feature selected from the group consisting of;
a) Clothing or body parts;
b) Colors, lights, movable parts;
c) Markings, patterns, symbols, numbers or sequences;
d) Sounds, music, buzzers, talking, laughing, screams;
e) Smells;
f) Tastes; and
g) Sensations, vibrations and textures.

11. The universal connectable collectable of claim 1 wherein the connectable collectable can be used for any purpose including at least one selected from the group consisting of;
a) Packaging/product packaging, or packaging parts—Containers of any type, food and beverage containers, boxes, cartons, cards, bottles, squeeze bottles, cans, squeeze tubes, caps, topes, clam shells, bags, letters, shrink wraps, cups, tops, cases, brief cases, handles and suitcases;
b) Toys;
c) Marketing including packaging, promotional items and premium items;
d) Personal care containers including lipstick tubes and cosmetic containers;
e) Dispensers;
f) Clothing and accessories including hand bags, shoes, socks, stockings, panty hose, underwear, bras, belts, hats, caps, combs, umbrellas, brief cases, zipper cases, glasses cases, jeans, pants, jackets, shorts, tops, zippers, snaps, hooks, handles, lower/upper body garments, gloves, coats, shirts, blouses, wallets, key chains, ties, scarves, handkerchiefs, manicure sets and finger nail clippers;
g) Jewelry including rings, bracelets, watches, earrings, necklaces and hair combs;
h) Ornaments including hood ornaments;
i) Decals;
j) Wrappings;
k) Bedding including sheets, towels, pillows, pillow cases, wash rags, blankets and covers;
l) Furniture and furnishings including furniture, lamps, rugs, vases, picture frames, cushions, pots, pans, kettles, glasses, mugs, cups and plates;
m) Electronics including cell phones, phones, radios, CDs, videos, digital video disks and televisions; and
n) Gambling games and equipment, including chips, cards, games of chance, lottery games and casino games.

12. The universal connectable collectable of claim 1 wherein the object or objects can be of any type (animate or inanimate), shape, size or composition.

13. The universal connectable collectable of claim 1 wherein the object or objects can be solid or hollow inside so that with the hollow collectable, various things or products can be stored inside, or the hollow object can serve as a product container.

14. The universal connectable collectable of claim 1 wherein the connector or connectors, can be positioned in different, or preferably the same location on an object, or parts of an object.

15. The universal connectable collectable of claim 1 wherein objects can be in one piece, but are preferably in more than one piece or part, preferably in two parts, that when joined or connected together, form the whole object.

16. A connectable collectable object or objects or parts of an object that when joined or connected create a finite or infinite group of connectable collectable objects.
